(19) United States
(12) Patent Application Publication
(10) Pub. No.: US 2006/0184416 A1
(43) Pub. Date: Aug. 17, 2006

(54) Method and apparatus for evaluation of business performances of business enterprise

(76) Inventor: Abhijit Nag, Pune (IN)

Correspondence Address: HEDMAN & COSTIGAN P.C., 1185 AVENUE OF THE AMERICAS, NEW YORK, NY, 10036, US

(21) Appl. No.: 11/059,760

(22) Filed: Feb. 17, 2005

(51) Int. Cl. G06F 17/60

(52) U.S. Cl. 705/11

(57) ABSTRACT

A method and apparatus for resource based evaluation of business performances of business enterprise is provided. The method provides a new company rating scheme using resource based profit points. The apparatus consists of a score card for cost drivers graded on 400 RTP points, a score card for value drivers graded on 600 RTP points, and a set of non financial performance measure questionnaires having a measurement index of 500 RTP points all adding up to a score of a maximum of 1500 RTP points said score card for cost drivers including weightages for the type of business and variables of resources such as money, material and energy, machines, manpower, management and, Information; the said score card for value drivers including weightages for type of business and variables of output such as money, material and energy, machines, manpower, management and, Information; and the said questionnaires separately giving weightages to parameters such as Quality, Employees, Customers & Strategy-representing pro-active nature of the management.

This invention relates to a method and apparatus for evaluation of business performances of business enterprise.

In particular, this invention relates to a method and apparatus, which in addition to enabling the evaluation of a business performance also performs an analysis by evaluating reasons, which held a business performance back from not achieving better results, so as to focus appropriately future actions for improvement.

Business performance evaluation has long been attempted in many ways. Some rating systems have attempted to evaluate this only on financial parameters while others have tried to include along with the non-financial parameters. The Rockwater's Balanced Scorecard is one such apparatus, which permits such evaluation.

These prior art evaluation devices have mechanisms to record past results to suggest whether a company's performance has been good, or, fair, or, requires improvement. But none of them suggests precisely what needs to be done in the future to change and improve the business performance.

The method and apparatus of the present invention attempts to not only evaluate a given company's performance in the past, but also skillfully analyses the reasons which held them back from not achieving better results, so as to focus appropriately their future actions for improvement.

This invention envisages a new methodology i.e. the resource based costing methodology for evaluating a business enterprise and provides a new form of company rating based on resource based profit [RTP] points.

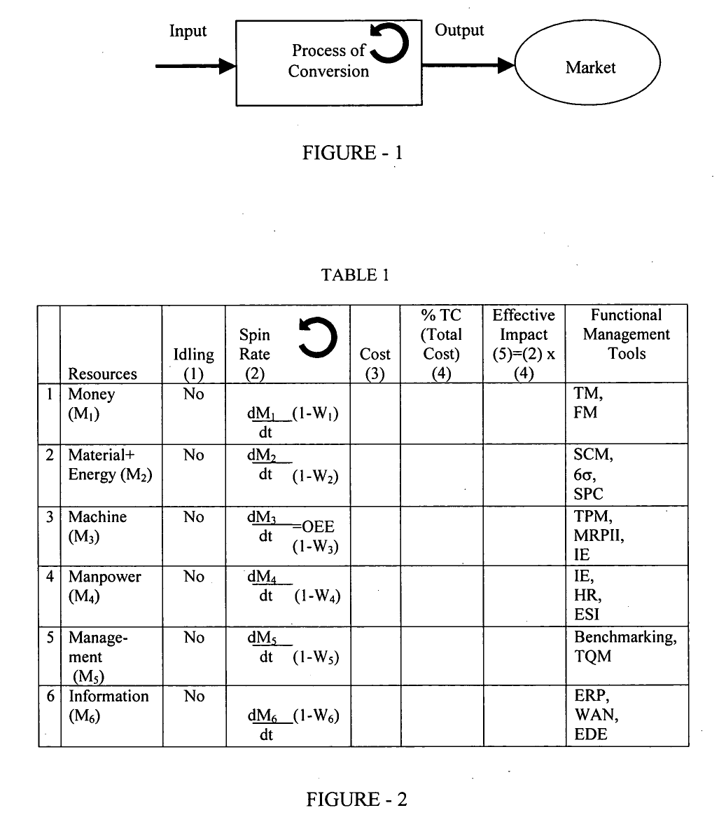

A typical business model consists of an input, which by a process of conversion leads to an output, which is taken to the market. The typical business model is depicted in FIG. 1 of the accompanying drawings.

Business basically amounts to identifying market opportunities for a given output product/service, setting up a least cost infrastructure (can be owned/leased) to deliver the same and to run to the asset in the most efficient way. Day to day management of business amounts to running the process of conversion most efficiently. The process of conversion will be most efficient, when the resources used therein are utilized most efficiently without any waste, so that the cost of the output product/service is the bare minimum and thereby one can afford to aggressively price its products to retain a dominant market position.

According to this invention there is provided a resource based costing method for evaluation of business performances of business enterprise, said method consisting of evaluating resource based cost weightages for the type of business of the enterprise, and variables of resources such as money, material and energy, machines, manpower, management and Information respectively; using the weightages so evaluated to score cost drivers relating to the said business enterprise on a grade 1 to 400 RTP points, evaluating the value weightages for type of business of the business enterprise and individual weightages for output such as money, material and energy, machines, manpower, management and, Information; and using the evaluated value weightages to score value drivers relating to the said business enterprise on a grade 1 to 600 RTP points, evaluating parameter weightages of parameters such as Quality, Employees, Customers & Strategy-representing pro-active nature of the management and using the evaluated parameter weightages to grade a set of non financial performance measure in the form of a pre prepared questions on a scoring index of 1 to 500 RTP points, adding the individual scores so achieved to a maximum of 1500 RTP points giving a score for evaluation of the business performance.

This invention also envisages apparatus for evaluation of business performances of business enterprise, said apparatus consisting of a score card for cost drivers graded on 400 RTP points, a score card for value drivers graded on 600 RTP points, and a set of non financial performance measure questionnaires having a measurement index of 500 RTP points all adding up to a score of a maximum of 1500 RTP points said score card for cost drivers including weightages for the type of business and variables of resources such as money, material and energy, machines, manpower, management and, Information; the said score card for value drivers including weightages for type of business and variables of output such as money, material and energy, machines, manpower, management and, Information; and the said questionnaires separately giving weightages to parameters such as Quality, Employees, Customers & Strategy-representing pro-active nature of the management.

Typically, the scorecard for cost drivers includes further subdivisions for variable cost measures and the scorecard for value drivers includes further subdivisions for variable value measures.

In accordance with a preferred embodiment of this invention the questionnaires are further subdivided into individual questions that have separately identified weightages. The weightages are alterable to suit dynamic situations real life situations.

The resources, which are used in the process of conversion, are (5 Ms+IT) as shown in table 1 FIG. 2 of the accompanying drawings. In the said table W=Weightage of rejects/process loss and OEE=Operating Equipment Efficiency.

The following statement therefore can represent a typical business model: Product interfacing Process interfacing another product, which strikes the market. In order to make the business process most efficient, we have to ensure that none of the resources which are pumped in the process, which cost the company dearly, are allowed to idle (wasted), or, allowed to produce products (not required), or, allowed to get spoilt during a production process as rejects/rework. Therefore, business management at the generation/manufacturing stage literally boils down to efficient resource management. The more vigorous is your activity here, the most cost competitiveness would you enjoy, with a given ‘product-process-market’ configuration.

FIG. 2 also illustrates the Functional Management Tools, which need to be used for improving the respective resource utilization, thereby increasing the efficiency of the process of conversion.

In FIG. 2, the following reference terms have the meaning mentioned alongside.

TM=Treasury Management

FM=Financial Management

SCM=Supply Chain Management

6σ=Six Sigma

TPM=Total Productive Maintenance.

MRRII=Manufacturing Resource planning II.

IE=Industrial Engineering

Benchmarking=Benchmarking Management Tool.

TQM=Total Quality Management.

ERP=Enterprise Resource Planning

WAN=Wide Area Networking

EDE=Electronic Data Exchange

ESI=Employees Satisfaction Index

For example, in order to improve efficiency of the first type of resource, ‘MONEY’, the Functional Management Tools (FMTs) that should be used are Treasury Management, and Financial Management. It will work as follows:

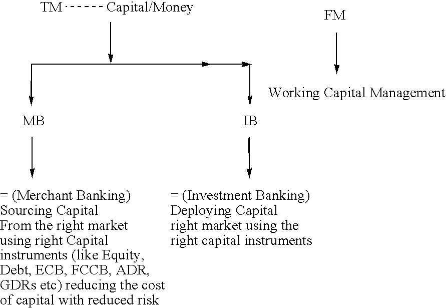

TM-tools should ensure least cost of capital and most profitable deployment of idle capital (Money). FM-tools should ensure highest use/efficiency of working capital.

Similarity, for other types of resources, in order improve non-idleness and increasing their spin rate, you should use the FMTS as mentioned in the last column of Table shown in FIG. 2.

The different variables in table 1 can be explained as follows:

(M₁) Money:

As a first step, you cannot allow money to idle—the money which has been used to raise the business and then to run it (fixed capital+working capital). If as an individual, you have US $ 100,000, in currency and you have kept them in the security of a safe in your bedroom, everyday before you go to bed at night, you open the safe to ensure that your money is safe and not stolen. It gets into your habit that you don't get a sound night's sleep, unless you open every night the bedroom safe and see your money parked there safely. Over a period of 3 years, though you have ensured the custodial safety of your money, but as you have allowed your money to idle, its economic value has been eroded by a whopping 15% (assuming annual average inflation rate of 5%). On the contrary, if you had rolled your money on some productive investment and earned a return on investment of at least 10%, then the differential increase in the resource (money) utilization would have been 15% (5%+10%). While the loss is perceptible for allowing money, as a resource, to idle in the case of an individual, the same holds true for a business enterprise as well.

Therefore no business enterprise should allow money to idle. Money should be raised at the least cost (WACC=weighted average cost of capital) through judicious and scientific merchant banking management/scientific capital structuring and utilized to the maximum. If there is surplus money from operations, or, other sources, they must not be allowed to idle (by parking them up in the current account of the company). They should be judiciously and scientifically put to use through ‘investment banking management’, so that profit generated from this operation can compliment that from normal business operation of the company. This forms ‘other income’ besides revenue from sales. An efficient merchant banking operation combined with an efficient investment banking operation for a company makes its treasury operation very efficient, which ensures non-idleness and highest spin rate of money, as a resource base.

(M₂) Material+Energy:

Like money as a resource base, material as a resource base must not be allowed to idle. For a products-company, material cost constitutes the highest resource-cost component. While manpower-cost for such companies should be attempted to be held within 10% of Total Cost (=TC), their material cost can be at times as high as 50% of the Total Cost (=TC). Such high cost resource should not be allowed to idle. Idling of material manifests itself as ‘inventory’. Thus we have total inventory carried by a company as:

$$\begin{matrix}Total \\ Inventory \\ Of a company\end{matrix} = \begin{matrix}Raw \\ Material \\ Inventory\end{matrix} + \begin{matrix}Work \\ In Process \\ Inventory\end{matrix} + \begin{matrix}Finished \\ Goods \\ Inventory\end{matrix}$$

$$I = RMI + WIPI + FGI$$

Raw materials inventory represents idling of raw materials—raw materials waiting and hence idling, waiting to be taken up for the process of conversion; similarly, work-in-progress inventory represent idling of materials, wherein part of the operations have been completed & waiting to be taken up for the balance operations and the finished-goods inventory represents idling of materials, all the operations have been completed and waiting to be sold to the customers/consumers. All these idling/waiting do not add any value to the materials (except in wine manufacturing) and are only cost-adding and therefore, must be ruthlessly avoided by a business enterprise. One should, therefore, attempt to drive a business inventory-less so as to effectively bring in Kanban and JIT in operations. The spin rate of materials as a resource should be targeted to increase by:
a) Reducing the process waste/rework [(1-w) is the effective output weight, ‘w’ being the process waste]. Yield should go up.
b) Reducing the throughput time of the conversion process [which includes producing the output product quickly and pushing it expeditiously through the outbound logistics system till it hit the ultimate consumer on the extreme end position].
c) Material cost should go down by better sourcing (effective BPO).

Thus material as a resource base, highest cost contributor, should achieve the following objectives at a progressively higher & higher level:
i. Inventory should come down
ii. Supply-chain throughput time should come down
iii. Process yield should up
iv. Material cost should go down

When the above results take place, column (5) in Table 1 (Resources-based costing), material as a resource cost will have its least impact on the end product, making your product-cost most competitive.

(M₃) Machine:

The machine, the manufacturing plant (for products-company) and the appropriate infrastructure (in other forms of business) must not be allowed to idle. Idling of infrastructure makes the process of conversion inefficient, and end-product cost less competitive.

Thus, if you have put up a new machining line for a new product of the company, you should check up the uptime of the machines periodically. If the uptime (or, utilization) is lesser than targeted (˜100%), one should analyze the causes of downtime, viz., operators absent, not trained, toolings inadequate, jigs and fixtures not fool-proof, loading and unloading of jobs time consuming, material nonavailability, market order nonavailability etc. and take immediate appropriate measures to plug the losses and increase the machine/infrastructure utilization.

The reasons for lower plant/infrastructure capacity utilization can be because of reasons related to manufacturing, or, reason related to marketing (lack of adequate orders), or, both. All of them have to be expeditiously addressed in order to make the process of conversion efficient, to be able to sustain the business.

In house reason should be addressed to increase OEE (=Operating Equipment Efficiency) by use of TPM, ERP application for M-M module (Manufacturing & Material) including PPC, (Production Planning & Control) etc., while the market-based reasons should be handled through effective selling and marketing, export market and even by undertaking contract manufacturing wherever found feasible.

Higher and higher infrastructure utilization should be attempted through application of Kaizen/Continuous Improvement Programme, being undertaken taking the involvement of all the employees of the enterprise. Effective improvement on the use of this resource base should help the company to:
(a) Increase the throughput volume of the conversion process
(b) Reduce the running cost/expenses/energy/consumption of the infrastructure/plant.
(c) Reduce TCO (=Total cost of ownership=acquisition cost+running cost) of the plant/machinery/infrastructure.

The result of all the above steps will be to make the least impact of column (5) in Table 1 (Resource-based costing) of machine/infrastructure as a resource cost on the end product, making the product-cost most competitive in the market, with a given product-process-market configuration.

(M₄) Manpower Resource:

Like other resources, manpower as a resource base cannot be allowed to idle. Manpower represents the most strategically important resource, which if properly harnessed can take an organization to great heights of achievement, and if not, can ruin the organization to a level of closure.

For a typical products company, in terms of a pure cost item, manpower cost should not exceed 10% of the total cost. If your company's average labor efficiency is just 70%, wherein you enjoy for your products a near monopoly in the market retaining a profit margin of 40%, you might decide not to push hard to increase this manpower efficiency by 25% to bring it to an acceptable level of 95%, facing, or, antagonizing, or, convincing the labor unions and workmen because it increases your profit margin by just 2.5% (as labor, or, manpower cost represents for your company 10% of the total cost). But strategically this would amount to a wrong management move, throwing a wrong signal that you accept inefficiency of manpower. Thus today's 70% may spiral down to 65%, to 60% and then to 50% and so on. Manpower controls the other resource bases also, and they might think that if you have allowed their inefficiencies, you might as well allow inefficiencies of other resource utilization also. This will turn, in no time, an otherwise healthy 40% profit margin to a loss, or negative margin. Therefore, manpower as a resource, for some companies, may not be very important from a cost point of view, but of immense importance from the company's strategic point of view. You must not allow the ‘work culture’ to be eroded; it takes years of hard toil to bring back a good and efficient work culture.

Therefore, you must ask more from your manpower. If they are giving 40 units per shift today, ask for 50 units; when they achieve 50 units, congratulate them and then ask for 60 units. Keep increasing the benchmark, and they have infinite capacity to respond to your ever-increasing demand. In the process, you are not giving injustice to them. In fact, you are providing the best justice to them. You are preparing them to produce better and better results, working closer and closer to their potential. This will increase their skill; develop their intellect, and their ability to do hard work, thereby increasing their market worth and marketability. The worst form of punishment, which can be inflicted on a human being, is to deny him any work. Provide him no work for 3 years, and he/she would be no better then a log of wood, a complete vegetable, capable of doing nothing. Therefore, if you want to make a human bring out of him/her, the only way is to load him/her with more and more work/task. Human beings can, therefore, be compared to diamonds. The more you polish them, the more shine do you get out of them. While rubbing you, therefore, don't feel that you are hurting, or doing injustice to them. Similarly, manpower as a resource base, strategically the most important resource, must be utilized to their best potential, always encouraged to scale higher and higher peaks of achievement. This will make the impacted cost in column (5) of Table I (Resource-Based Costing) on the end product the least, making the product-cost most competitive.

(M₅) Management:

You may have all the above 4 resources, but bad management may while away all the resources and not take the synergistic benefits. Therefore management as a resources base is the most critical one—they have the capacity to make it, or, break it. Their vision for the company, selecting the most appropriate product-process-market configuration, sourcing the products/product-delivery infrastructure economically and running the infrastructure most efficiently makes the company's operations most profitable and thereby, ensuring economic value addition (EVA) in a continuous, and ever-sustaining way. These organizations essentially dominate the markets through eternity.

(M₆) Information:

Generating information, transmitting them to all over the decision-making process, making them two-way communication, help the organization run their operations more efficiently and transparently. Management decision-making should be more and more data and information-driven, quantitative, transparent and objective, rather than being subjective based on hunches, intuitions, gut-feelings and here-says.

Information provides forward visibility and makes the operations highly efficient. If your visibility is not clear, you tend to become defensive and tend to hedge your future by carrying higher inventory of products in the supply-chain-pipeline making your operation lesser efficient.

More and more use of information will make the organization work on a real-time basis increasing the efficiency significantly. Therefore, information as a very important resource base, should achieve the following objectives:
(a) Company-wide computerization as a first step and then computerization across the supply-chain.
(b) On-line connectivity within a lead-firm operation through integrated ERP implementation.
(c) Wide area networking across operating platforms and supply-chain partners.
   III. Cost Calculation:

Costing of a product has been done till today by two methodologies:
(i) Element-wise cost build-up
(ii) Variability-wise cost build-up
   I. Element-Wise Cost Build-Up:

Here product cost is built-up from material cost, labor cost and expenses, each of which is broken into ‘direct’ and ‘indirect’

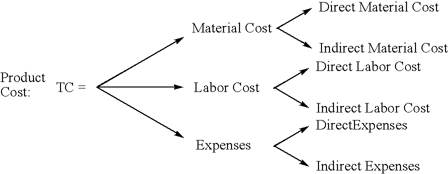

Direct materials are those materials, which are directly identifiable or, visible in the end product, and their costs are not of insignificant proportions like steel items of an automobile, or, cloth used for making garments in a garment industry etc. Costs of such direct materials are direct material costs. Materials, which are not directly identifiable, or, visible with the end product, or, though visible but of insignificant proportions, or, values, are called indirect materials. For example, button and threads in the garments though visible in the end product are treated as indirect materials, due to their insignificant proportions in the total cost of the product.

Similarly, direct labor are those manpower who are directly engaged in the productions of end products of the company, like operators working on the machines for production of component parts and assembly of finished goods of the company. All other manpower engaged in providing support services to this direct production activity, like people working in maintenance department, accounts department, HR department etc. are indirect workmen. Costs of direct labor are called direct labor cost, which includes their salaries and wages and other indirect benefits given to them. Similarly, costs associates with indirect labor are called indirect labor cost.

In the same way, expenses, which are directly identifiable with the production of finished goods of the company, like electricity consumption of the production shops of the company, are called direct expenses and all other expenses are termed as indirect expenses. The summary of total cost (TC) of the product can be written as follows:

$$\begin{matrix}TC = MC + LC + E \\ = ( DMC + IMC ) + ( DLC + ILC ) + ( DE + IDE ) \\ = ( DMC + DLC + DE ) + ( IMC + ILC + IDE )\end{matrix} \\ TC = Prime Cost + Overheads Costs \\ Where \text{:} \\ MC = Material Cost . \\ DMC = Direct Material Cost . \\ TC = Total Cost of the product \\ LC = Labor Cost . \\ DLC = Direct Labor Cost . \\ IDMC = Indirect Material Cost . \\ IDLC = Indirect Labor Cost . \\ E = Expenses . \\ DE = Direct Expenses . \\ IDE = Indirect Expenses . \\ PC = Prime Cost . \\ FC = Factory Cost . \\ CP = Cost of Production . \\ CS = Cost of Sales . \\ SP = Sales Price . \qquad ( 1 )$$

Now, Overhead Costs can be broken into three parts, depending on where the overhead expenses have been spent like:

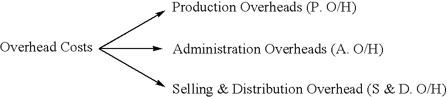

Thus equation no. (1) can be rewritten as:

$$TC = PC + P O / H + A O / H + S \& D O / H \qquad ( 2 )$$

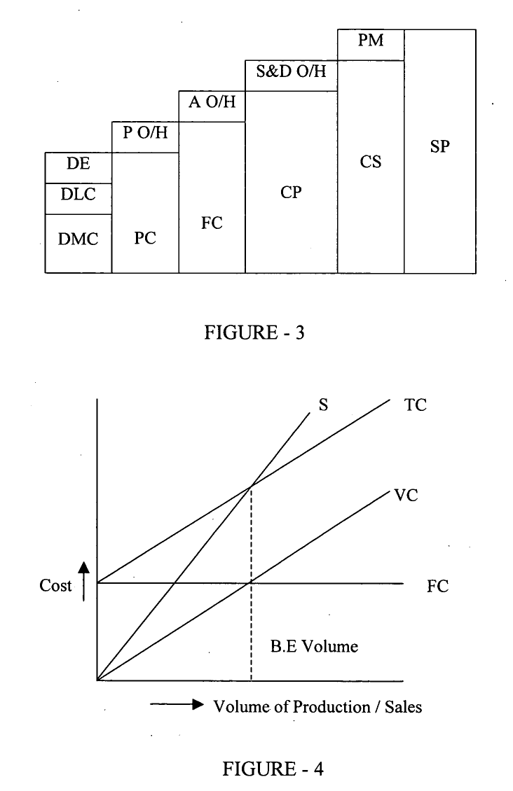

This equation is pictorially represented in FIG. 3 of the accompanying drawings.

Element wise cost build-up, or, break-up in the reverse order, is done by the above methodology.

II. Variability-Wise Cost Build-up:

Here the total cost of the product in broken into/built-up from two components-fixed cost and variable cost. This methodology is also called marginal costing technique, or, Cost-Volume-Profit analysis.

CVP analysis or, Marginal Costing technique is graphically depicted in FIG. 4 of the accompanying drawing:

Referring to FIG. 4 of the drawing the following equation can therefore be deduced:

$$TC = FC + VC \qquad ( 3 )$$

Where:
TC=Total Cost of the product.
FC=Fixed Cost.
VC=Variable Cost.
S=Sales.

This methodology of finding the total cost, also called Break-even analysis, is variability-wise build-up of total cost of a product.

The apparatus of this invention develops a third alternative method of product cost build up—based on the 6 Resources used to produce the product.

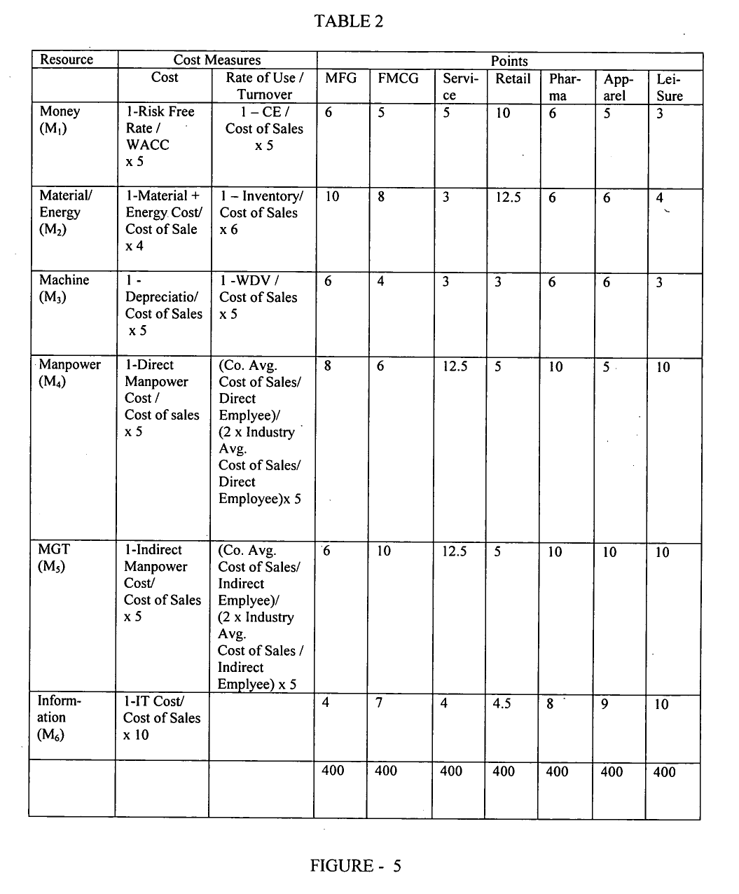

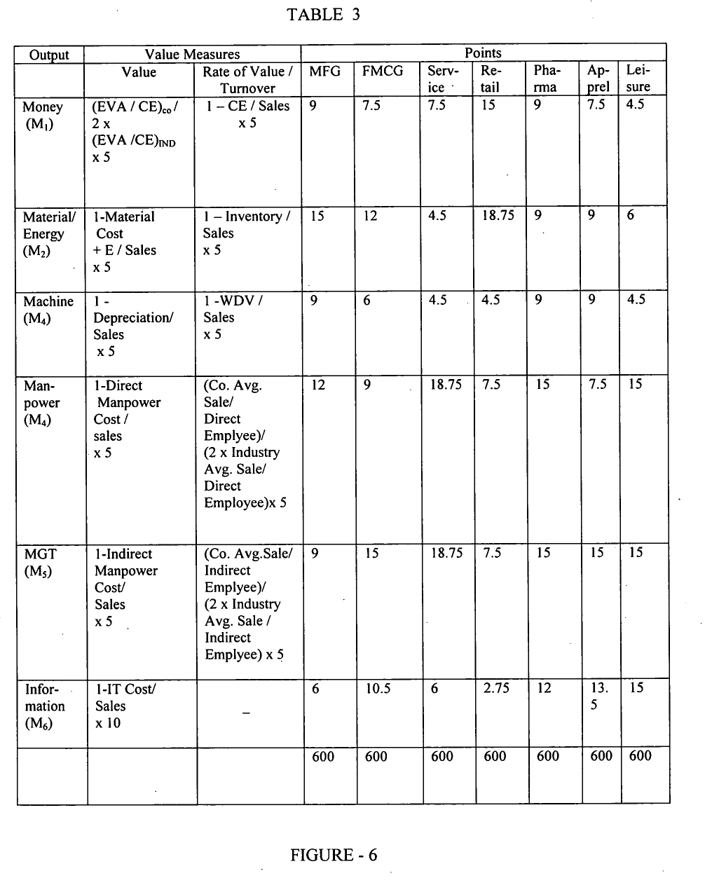

This resource-based costing methodology has been used to find the efficiency, or, rating of business enterprises. Therefore, 6Ms as seen in the score card of FIGS. 5 and 6 of the accompanying drawings have a cost-based measurement index, graded on 400 RTP points and also a value-based measurement index, graded on 600 RTP points. Besides non-financial performance measures have been a measurement index of 500 RTP points, all adding up together to a scorecard of 1500 RTP points.

In FIG. 5, WACC=weighted average cost of capital. In FIG. 6 EVA stands for economic value addition.

A company's performance in tracked on the basis of cost drivers (400 RTP points), value drivers (600 RTP points) and non-financial performance measures (500 RTP points). The shortcomings are identified, analyzed and short-term and long-term action plans are suggested for implementation by the company.

The implementations programmed are also tracked along to record the improvement.

Different weightages, have been given for different types of business, taking into consideration the unique features of each domain of business and industry.

The weightage RTP points may be altered depending on experience and expediency of the cases.

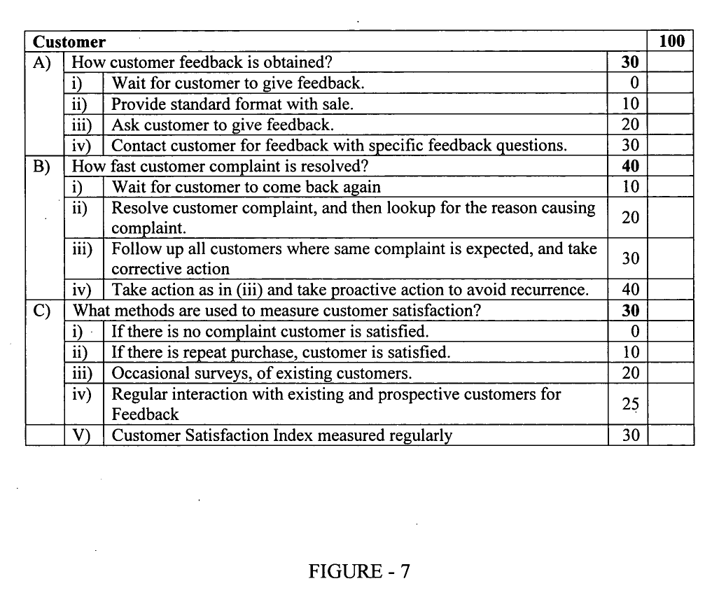

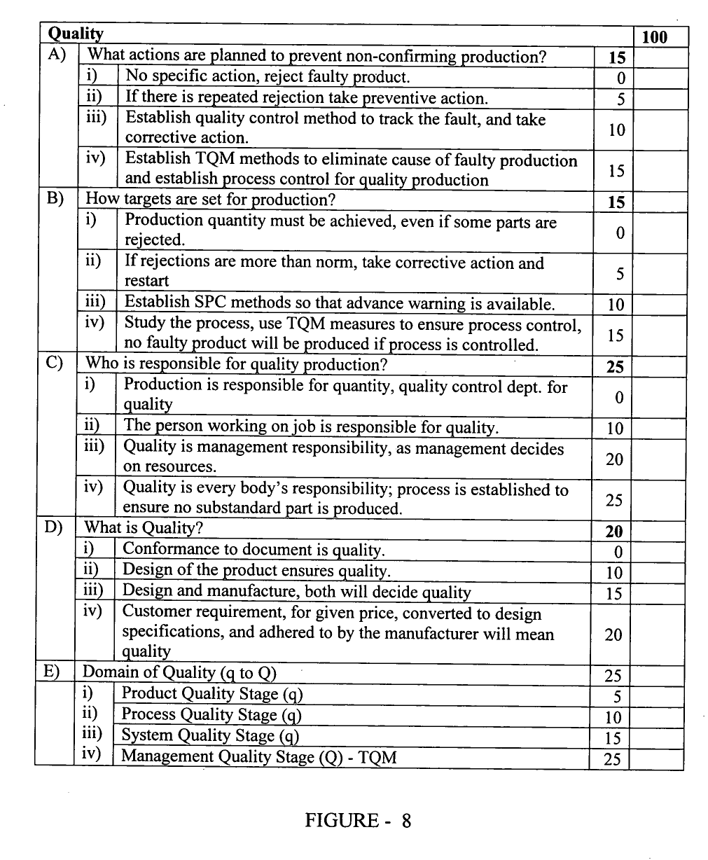

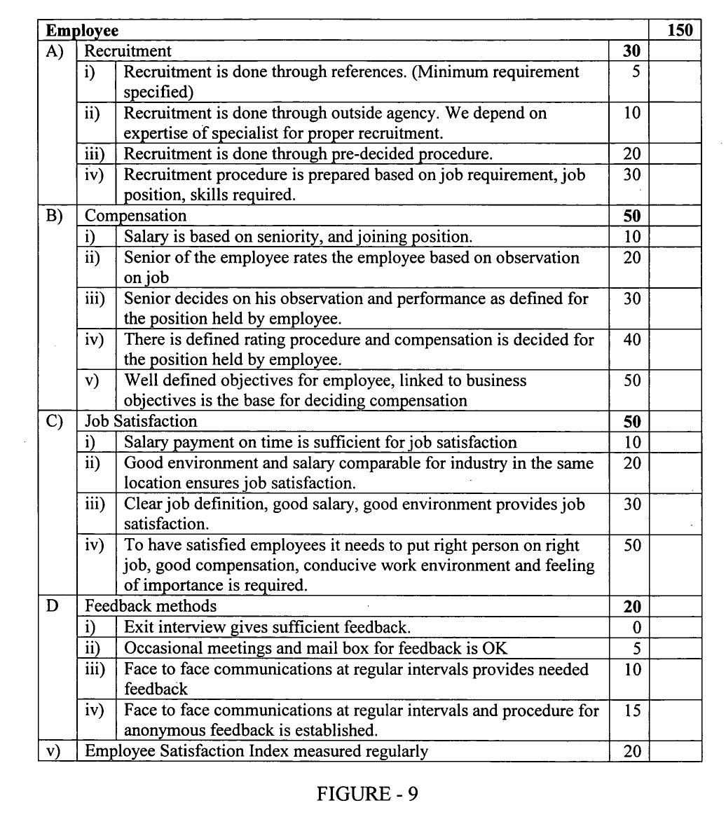

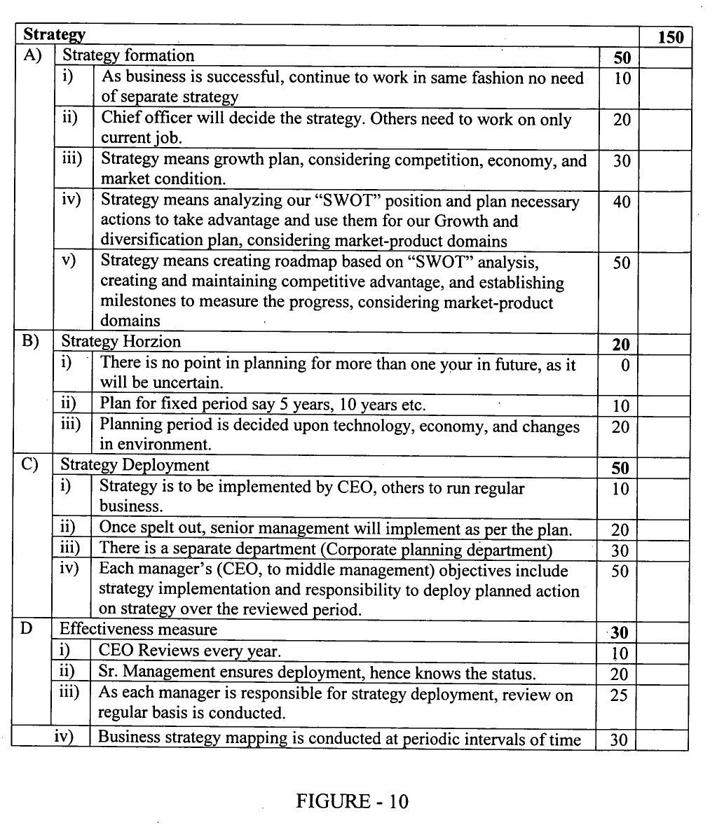

Non-financial performance measure is evaluated on the basis of a set of questionnaire prepared on 4 important business parameters—Quality, Employees, Customers & Strategy-representing pro-active nature of the management. The questionnaire and weightage RTP points are liable to be changed, as and when deemed necessary depending on experience and expediency of the cases. The questionnaire forming part of the apparatus and method of this invention is shown in FIG. 7 to 10 of the accompanying drawing and is self-explanatory.

The business rating is not a passive tool but an active and dynamic tool of application to strategically turn around a company towards a dramatic and guaranteed improvement. This resource-based costing methodology has been used to find the efficiency, or, rating of business enterprises. Therefore, 6 Ms have a cost-based measurement index, graded on 400 RTP points and also a value-based measurement index, graded on 600 RTP points. Besides non-financial performance measures have been a measurement index of 500 RTP points, all adding up together to a scorecard of 1500 RTP points.

The scheme of company rating envisaged by this method are as follows:

1300 to 1500 RTP points gives an RTP score of PPPP

1100 to 1300 RTP points gives an RTP score of PPP

800 to 1 100 RTP points gives an RTP score of PP

600 to 800 PTP points gives an RTP score of P

<600 RTP points gives an RTP rating score of P−

The invention will now be described with respect to the accompanying examples:

### EXAMPLE 1

A) Sector: Manufacturing

B) Name of the Company: ABC Co. Ltd., engaged in manufacturing of automobiles

C) Business Operations: The company is engaged in manufacturing different types of automobiles, starting with manufacturing different types of automobiles, starting with Heavy Commercial Vehicle (HCV), commercial Vehicle (Cr). Light Commercial Vehicle (LCV), Multi Utility Vehicle (MUV), Sports Utility Vehicle (Suv) and Passenger cars of B and C-Segment. The company has 4 large plants scattered around different corners of a country. Recently the company has bought an overseas company manufacturing automobiles. The company has its own R & D center, designing its own vehicles. The company initially had a technical collaboration with a well-known multinational of automobile manufacturing; the technical collaboration now does not exist and the company has over the years developed its own design capabilities. For the last many years, all the vehicles launched by the company in the market have been designed and prototyped, and productionised and have met with substantial success in the local country market. Expert efforts to the developing countries of other continents have also borne reasonable success.

D) Financials: For the accounting year 2003-04, the key financials are given below:
Distribution of Revenue
2003-2004
($ Million) $=USD

Materials 18,64.48(54.55%)

Shareholder 62.00 (1.81%)

Reserve $ 108.15 (31.16%)

Operation & Other Expenses: 457.04 (13.37%)

Depreciation and Anortisation: 84.09 (2.46%)

Interest: 35.44 (1.04%)

Taxes & Duties: 612.96 (17.93%)

Employees: 193.95 (5.65%)

Sources of Revenue

2003-2004

($ Million)

Vehicle Sales 2930.08(85.7%)

Vehicle Spare Parts 145.69 (4.3%)

Hire Purchase 30.76 (0.9%)

Exports 228.95 (6.7%)

Others 69.69 (2.00%)

Divided/Other Income 12.95 (0.4%)

The financial results of the company for the last 2 years (203-04 and 2003-03) are given below:

IUSD = 45.5 INR
Profit & Loss Account

| | | | 2003-04 | 2002-03 |
|---|---|---|---|---|
| | | | ($ million) | ($ million) |
| (i) | Gross Revenue: | | 3,405.17 | 2,382.57 |
| (ii) | Net Revenue (excluding excise duty): | | 2,906.20 | 1,999.32 |
| (iii) | Total Expenditure: | | 2,492.62 | 1,748.90 |
| (iv) | Operating Profit: | | 413.58 | 250.42 |
| (v) | Other Income: | | 12.95 | 3.96 |
| (vi) | Profit before Interest, Depreciation & | | 426.53 | 254.38 |
| | Amortization: | | | |
| (vii) | Interest: | | | |
| | (a) | Gross Interest: | 45.42 | 70.30 |
| | (b) | Adjustment/Transfer to Capital Amount | (9.98) | (8.99) |
| | (c) | Net Interest: | 35.44 | 61.31 |
| (viii) | Cash Profit: | | 391.09 | 193.08 |
| (ix) | Product Development Expenses: | | 11.35 | — |
| (x) | Depreciation/Amortisation: | | 84.09 | 79.59 |
| (xi) | Profit for the year before extra ordinary/ | | 295.65 | 113.49 |
| | Exceptional items: | | | |
| (xii) | Extra-ordinary/Exceptional items: | | 11.62 | 1.32 |
| (xiii) | Profit Before Tax: | | 284.03 | 112.17 |
| (xiv) | Provision for Taxation: | | | |
| | (a) | Current (Net of Provisions written back) | 21.10 | 4.33 |
| | (b) | Deferred (includes Provisions for | 84.84 | 41.88 |
| | | earlier years): | | |

| | | | |
|---|---|---|---|
| (xv) | Profit After Tax: | 178.10 | 65.96 |
| (xvi) | Investment Allowance (utilized) Reserve | — | 0.20 |
| | Written Back: | | |
| (xvii) | Balance Brought Forward from Previous year: | 27.19 | — |
| (xviii) | Amount Available for Appropriations: | 205.29 | 66.16 |

Appropriations:

| | | | |
|---|---|---|---|
| (a) | General Reserve: | 54.95 | 7.25 |
| (b) | Dividend: | | |
| | Interim: | 30.76 | — |
| | Final: | 31.24 | 28.11 |
| (c) | Tax on Dividend: Interim | 3.44 | — |
| (d) | balance carried to Balance Sheet: | 80.40 | 27.19 |

IUSD = 45.5 INR

| | |
|---|---|
| Balance Sheet as on | (Million USD) |
| 31^{st} Mar. 2004 | 31 Mar. 2003 |

Sources of Funds:

| 1. | Shareholders Funds: | | | | |
|---|---|---|---|---|---|
| | (a) | Capital | 78.24 | | 70.29 |
| | (b) | Reserves & Surplus: | 711.38 | | 500.51 |
| | | | 789.80 | 570.80 | |
| 2. | Loan Funds: | | | | |
| | (a) | Secured: | 207.18 | | 227.98 |
| | (b) | Unsecured: | 69.69 | 276.87 | 92.53 |
| | | | | 320.51 | |

| | | | |
|---|---|---|---|
| 3. | Deffered Tax Liability (Net): | 113.00 | 23.14 |
| 4. | Total Funds Employed: | 1,179.67 | 914.45 |

Application of Funds

| 5. | FIXED ASSETS: | | | | |
|---|---|---|---|---|---|
| | (a) | Gross Block | 1315.47 | | 1294.28 |
| | (b) | Less:Depreciation/Amortisation | 664.55 | | 596.28 |
| | (c) | Net Block | 650.92 | | 698.00 |
| | (d) | Capital Work-in-Progress | 62.88 | | 42.23 |
| | | | 713.80 | 740.23 | |
| 6. | INVESTMENTS | | | 671.82 | 279.80 |
| 7. | Current Assets, Loan & Advances | | | | |
| | (a) | Inventories | 252.18 | | 254.78 |
| | (b) | Sundry Debtors | 135.16 | | 207.93 |
| | (c) | Cash and Bank Balances | 169.34 | | 53.92 |
| | (d) | Loans and Advances | 255.56 | | 138.74 |
| 8. | CURRENT LIABILITES & PROVISIONS | | | | |
| | (a) | Current Liabilities | 928.42 | | 697.86 |
| | (b) | Provisions | 94.64 | | 69.43 |

| | | | |
|---|---|---|---|
| 9. | Net Current | (210.82) | (111.90) |
| | Asset [= 7-8] | | |
| 10. | Miscellaneous Expenditure | 4.88 | 6.61 |
| | (to the extent not written off, or, adjusted) | | |
| | | 1,179.67 | 914.45 |

E) RTP-Rating Calculation:-

XYZ Motors Ltd {a large automobile manufacturing company} was evaluated using the apparatus and method in accordance with this invention

${A}^{*} \underline{Industry Domain} \text{:} Mfg$

| Cost Measure: | |
|---|---|
| (1) | (a) WACC = 15% |
| | Risk Free = 6% |

| | |
|---|---|
| MONEY | $\frac{WACC}{Risk Free} = \frac{15}{6} = 2.50$ |

$( 1 - \frac{Risk free rate}{WACC} )$
$= ( 1 - \frac{1}{2.5} ) \times 30 = 18 \text{/} 30$

| | |
|---|---|
| (b) | Cost of Sales = 11,724.00 Cr. (INR) |

CE = 4,853.37 Cr. (INR)

$( 1 - \frac{CE}{COS} ) \times 5 \times 6$
$= ( 1 - \frac{4 \text{,} 853.37}{11 \text{,} 724.00} ) \times 30 = 17.58 \text{/} 30$

$therefore ( a ) + ( b ) = 35.58 \text{/} 60$

(2)

| | |
|---|---|
| (a) | Cost of Sales = 11,724.00 Cr. (INR) |
| | Material Cost + E = 8,555.93 Cr. (INR) |

× 4 × 10

| | |
|---|---|
| MATERIAL | $( 1 - \frac{Material Cost + E}{Cost of Sales} ) \times 4 \times 10$ |
| $= ( 1 - \frac{8 \text{,} 555.93}{11 \text{,} 724.00} ) \times 40 = 10.81 \text{/} 40$ | |

| | |
|---|---|
| (b) | Cost of Sales = 11,724.00 Cr. (INR) |
| | Inventory = 722.92 Cr. (INR) |

× 6 × 10

$( 1 - \frac{Inventory}{Cost of Sales} ) \times 6 \times 10$
$= ( 1 - \frac{722.92}{11 \text{,} 724.00} ) \times 60 = 56 \text{/} 60$

$66.81 \text{/} 100$

| | MACHINE |
|---|---|
| (3) | (a) Cost of Sales = 11,724.00 Cr. |
| | Depn. = 382.60 Cr. |

× 5 × 6

$( 1 - \frac{Depn .}{Cost of Sales} ) \times 5 \times 6$
$= ( 1 - \frac{382.6}{11 \text{,} 724} ) \times 30 = 29.02 \text{/} 30$

(b) Cost of Sales = 11,724.00 Cr. (INR)
WDV = 2,961.71 Cr. (INR)

× 5 × 6

$( 1 - \frac{WDV}{Cost of Sales} ) \times 30$
$= ( 1 - \frac{2 \text{,} 961.71}{11 \text{,} 724.00} ) \times 30 = 22.42 \text{/} 30$
$therefore ( a ) + ( b ) = 51.44 \text{/} 60$

| | MANPOWR: |
|---|---|
| (4) | (a) Cost of Sales = 11,724.00 Cr. (INR) |
| | Direct Labour Cost = 617.74 Cr. (INR) |

× 5 × 8

$( 1 - \frac{Direct Labour Cost}{Cost of Sales} ) \times 40$
$= ( 1 - \frac{617.74}{11 \text{,} 724.00} ) \times 40 = 37.89 \text{/} 40$

(b) Cost of Sales = 11,724.00 Cr. (INR)
No. of Direct Employees = 20,590

Cost of Sales/Direct employee = 56.94 lakhs (INR)

Industry avg. cost of sales/employee = 40 lakhs

$\frac{Co . avg . cost \text{/} direct employee}{2 \times industry avg . cos \text{/} direct employee} \times 5 \times 8$
$= \frac{56.94}{2 \times 40} \times 5 \times 8 = 28.47 \text{/} 40$

$66.36 \text{/} 80$

| | MANAGEMENT: |
|---|---|
| (5) | (a) Cost of Sales = 11724.00 Cr. (INR) |
| | Indirect Manpower cost = 264.75 Cr (INR) |

× 5 × 6

$( 1 - \frac{Indirect Manpower Cost}{Cost of Sales} ) \times 5 \times 6$
$= ( 1 - \frac{264.75 Cr .}{11 \text{,} 724.00} ) \times 5 \times 6 = 29.32 \text{/} 30$

(c) Cost of Sales = 11,724.00 Cr. (INR)
No. of indirect employees = 4,412
Cost of Sales/indirect employee = 265.73 lakh
Industry avg. cost of sales/indirect employee = 200 lakhs

$\frac{Co . avg . cos \text{/} indirect employee}{2 \times industry avg . cos \text{/} in direct employee} \times 5 \times 6$
$= \frac{265.73}{2 \times 200} \times 30 = 19.93 \text{/} 30$

$therefore ( a ) + ( b ) = 49.25 \text{/} 60$

| | INFORMATION TECHNOLOGY: |
|---|---|
| (6) | Cost of Sales = 11,724.00 Cr. (INR) |
| | IT Cost = 32 Cr. |

| | |
|---|---|
| IT | $( 1 - \frac{IT Cost}{Cost of Sales} ) \times 10 \times 4$ |
| $= ( 1 - \frac{32}{11 \text{,} 724} ) \times 40 = 39.89 \text{/} 40$ | |

$39.89 \text{/} 40$

$COST MEASURE Σ 309.33 \text{/} 400$

| VALUE MEASURE: - | | |
|---|---|---|
| | MONEY: | |
| (1) | (a) S = 13,282 Cr. (INR) | |
| | EVA/CE = 9.4% CE = 4,853.37 Cr. | $\frac{\begin{matrix}( EVA \text{/} CE ) industry = 7.5 \% \\ ( EVA \text{/} CE ) co . \times 5 \times 9\end{matrix}}{2 \times ( EVA \text{/} CE ) industry}$ |

$= \frac{9.4}{2 \times 7.5} \times 45 = 28.2 \text{/} 45$

| | |
|---|---|
| (b) | $\frac{CE}{Sales}$ |

$( 1 - \frac{CE}{Sales} ) \times 5 \times 9$
$= ( 1 - \frac{4 \text{,} 853.37}{13 \text{,} 282} ) \times 45 = 28.55 \text{/} 45$

$therefore ( a ) + ( b ) = 56.75 \text{/} 90$

| | MATERIAL: |
|---|---|
| (2) | (a) Material Cost + Energy = 8,555.93 Cr. |

S = 13,282 Cr.
$( 1 - \frac{( Material + E ) Cost}{Sales} ) \times 5 \times 15$
$= ( 1 - \frac{8555.93}{13 \text{,} 282} ) \times 75 = 26.69 \text{/} 75$

(b) S = 13,282 Cr. (INR)
Inventory = 722.92 Cr. (INR)

$( 1 - \frac{Inventory}{Sales} ) \times 5 \times 15$
$= ( 1 - \frac{722.93}{13 \text{,} 282} ) \times 75 = 70.92 \text{/} 75$

$therefore ( a ) + ( b ) = 97.61 \text{/} 150$

| | MACHINE: |
|---|---|
| (3) | (a) S = 13,282 Cr. |
| | Depn. = 382.60 Cr |

$( 1 - \frac{Depn .}{Sales} ) \times 5 \times 9$
$= ( 1 - \frac{382.60}{13 \text{,} 282} ) \times 45 = 43.70 \text{/} 45$

(b) S = 13,282 Cr
WDV = 2,961.71 Cr

$( 1 - \frac{WDV}{Sales} ) \times 5 \times 9$
$= ( 1 - \frac{2 \text{,} 961.71}{13 \text{,} 282} ) \times 45 = 34.97 \text{/} 45$

$therefore ( a ) + ( b ) = 78.67 \text{/} 90$

| | MANPOWER: |
|---|---|
| (4) | (a) S = 13,282 Cr. |

Direct Labour Cost = 617.74 Cr.

$( 1 - \frac{Direct Labour Cost}{Sales} ) \times 5 \times 12$
$= ( 1 - \frac{617.74}{13 \text{,} 282} ) \times 60 = 57.21 \text{/} 60$

```
(b) S = 13,282 Crore
  No of direct employees = 20,590
  Sales/direct employee = 64.51 lakhs
  Industry avg. sales/direct employee = 50 lakhs
```

$\frac{Co . avg . sales \text{/} direct employee}{2 \times industry avg . sales} \times 5 \times 12$
$= \frac{64.51}{2 \times 50} \times 60 = 38.71 \text{/} 60$

$therefore ( a ) + ( b ) = 95.92 \text{/} 120$

| | MANAGEMENT: |
|---|---|
| (5) | (a) Sales = 13,282 Cr. |
| | Indirect Manpower cost = 264.75 Cr |

$( 1 - \frac{Indirect Manpower Cost}{Sales} ) \times 5 \times 9$
$= ( 1 - \frac{264.75}{13 \text{,} 282} ) \times 45 = 44.10 \text{/} 45$

```
(b) Sales = 13,282 Cr.
  No. of indirect employees = 4,412
  Sales/indirect employee = 310.04 lakhs
  Industry avg. sales/indirect employee = 240 lakhs
```

$\frac{Co . avg . sales \text{/} direct employee}{2 \times industry avg . sales \text{/} indirect employee} \times 5 \times 9$
$= \frac{310.04}{2 \times 240} \times 45 = 29.07 \text{/} 45$

$73.17 \text{/} 90$

| | INFORMATION TECHNOLOGY: |
|---|---|
| (6) | Sales = 13,282 Cr. |
| | IT Cost = 32 Cr. |

$( 1 - \frac{IT Cost}{Sales} ) \times 10 \times 6$
$= ( 1 - \frac{32}{13 \text{,} 282} ) \times 60 = 59.85 \text{/} 60$

$59.85 \text{/} 60$

$VALUE MEASURE \text{:} Σ 461.97 \text{/} 600$

NON FINANCIAL PERFORMANCE MEASURE

| | |
|---|---|
| 1) CUSTOMER: | 90/100 |
| 2) QUALITY: | 90/100 |
| 3) EMPLOYEE: | 100/150 |
| 4) STRATEGY: | 110/150 |

Σ = 390/500

$XYZ Motors Ltd Σ Σ = \frac{1161.30}{1500}$
RTP Rating Grade: PPP

### EXAMPLE—II

A) Business Sector: Pharmaceutical/FMCG

B) FMCG. Ltd., engaged in products of herbal specialist in health care and personal care.

C) Business Operations:

The company's products are household names in the largest democratic country of the world, engaged in the business of products of personal care (consumer care division) and healthcare (consumer health care division). Besides, the company has developed a separate Foods Business division. A very brief outline of there different busiess groups of the company are enumerated below-
(I) Consumer Care
Division (CCD): With the company's new exclusive focus on the FMCG space, the erstwhile personal care products division and the health care products division have been merged to form the Consumer Care Division (CCD)-which deals with pure FMCG products. The division's portfolio includes health supplements, digestives and confectionery, oral care, hair care and baby and skin care. The chart ‘C’ given below shows the relative sales composition for 2003-04.
(II) Consumer Healthcare

Division (CHD):

| | |
|---|---|
| Oral Care/Skin Care | 20% |
| Health Supplements | 23% |
| Digestive and Candies | 13% |
| Hair Care | 37% |
| FIG. C | |

Composition of Consumer Care Portfolio
The consumer health care division of the company includes products of the erstwhile Ayurvedic specialists division and a set of over the consumer (OTC) products based on the ayurvedic medicinal platform.
(III) Foods Business Division: This is a wholly owned subsidiary of the company and markets natural fruit juices, ethnic cooking pastes, sauces and tea 2003-04 has been a landmark year for this company. Not only did the sales grow lay 24.2% from USD 15.186 million in 2002-03 to 18.857 millions in 2003-04, but the company recorded a positive PAT of $ 0.330 million for the first time in its short history.

D) Financials:

| | 18 Units in | |
|---|---|---|
| | US $ million | |
| | For | For |
| | Year | year |
| | Ending | ending |
| | on | on |
| Pofit & Loss Account | 31.3.04 | 31.3.03 |
| Income: | | |
| Sales less returns: | 252.30 | 270.83 |
| Other Income: | 2.43 | 1.82 |
| Total Income | 254.73 | 272.65 |
| Expenditure: | | |
| Cost of Materials | 110.59 | 114.55 |
| Excise Duty | 14.37 | 16.12 |
| Manufacturing Expenses | 5.60 | 6.52 |
| Payments to and Provisions for Employee | 16.61 | 20.62 |
| Selling & Administration Expenses | 77.18 | 84.89 |
| Financial Expenses | 1.52 | 3.75 |
| Miscellaneous Expenditure Written off: | 0.46 | 0.35 |
| Depreciation | 3.46 | 4.84 |
| Total Expenditure | 229.79 | 251.64 |
| Balance being Net Profit | 24.94 | 21.01 |
| Balance brought forms | 14.53 | 9.82 |
| Provision for Taxation of earlier years written back: | 0.04 | 0.01 |
| Transferred from Debenture Redemption Reserve | 0.55 | 0.55 |
| | 40.06 | 31.39 |
| Provision For Taxation: Current | 1.92 | 1.63 |
| Deferred | 0.76 | 0.66 |
| Provision for taxation for earlier year: | 0.06 | 0.05 |
| Interim Dividend : | 3.77 | 3.14 |
| Proposed Final Dividend | 8.81 | 5.65 |
| Corporate Tax or Interim Dividend: | 0.48 | 0.00 |
| Corporate Tax on Proposed Final Dividend: | 1.13 | 0.72 |
| Transferred to Capital Reserve: | 0.34 | 0.04 |
| Transferred to General Reserve: | 4.95 | 4.95 |
| Balance Carried Over to balance Sheet | 17.84 | 14.55 |
| | 40.06 | 31.39 |
| | As on | As on |
| Balance Sheet | 31.3.03 | 31.3.03 |
| Shareholders' Funds: | | |
| (A) Share Capital | 6.29 | 6.28 |
| (B) Reserves & Surplus: | 52.75 | 84.07 |
| | 59.04 | 90.35 |
| Loan Funds: | | |
| (A) Secured Loans: | 4.19 | 6.37 |
| (B) Unsecured Loans: | 4.55 | 17.80 |
| | 8.74 | 24.17 |
| Deferred Tax Liability: | 1.75 | 0.86 |
| Application of Funds: | 69.53 | 115.38 |
| Fixed Assets: | | |
| (A) Gross Block | 60.33 | 70.76 |
| (B) Less: Depreciation | 26.28 | 25.78 |
| (C) Net Block | 34.05 | 44.98 |
| INVESTMENTS | 37.63 | 27.19 |
| Deferred Tax Assets: | 0.13 | 0.07 |
| Current Assets. Loan & Advances | | |
| (a) Inventories | 24.51 | 39.26 |
| (b) Sundry Debtors | 9.24 | 25.64 |
| (c) Cash and Bank Balances | 2.61 | 8.26 |
| (d) Loans and Advances | 11.84 | 16.09 |
| | 48.20 | 89.25 |

| | | | |
|---|---|---|---|
| Less: | | | |
| CURRENT LIABILITES & PROVISIONS | | | |
| (a) Liabilities | 36.16 | 35.14 | |
| (b) Provisions | 15.76 | 11.51 | |
| | 51.92 | 46.64 | 42.61 |

| | | |
|---|---|---|
| Net Current Assets: | (3.72) | |
| Miscellaneous Expenditure | 1.44 | 0.53 |
| (to the extent not written off, or, adjusted) | | |
| | 69.53 | 115.38 |

E) RTP-Rating
Calculation: FMCG Ltd.

${A}^{*} \underline{Industry Domain} \text{:} FMCG \text{/} PHARMA$

| Cost Measure: | |
|---|---|
| (1) | (a) WACC = 16% |
| | Risk Free = 6% |

| | |
|---|---|
| MONEY | $\frac{WACC}{Risk Free} = \frac{16}{6} = 2.67$ |
| | $( 1 - \frac{Risk free rate}{WACC} ) \times 5 \times 5$ |
| | $= ( 1 - \frac{6}{16} ) \times 25 = 15.63 \text{/} 25$ |

(b) Cost of Sales = 1,038 Cr.

CE = 308.46 Cr.

$( 1 - \frac{CE}{COS} ) \times 5 \times 5$
$= ( 1 - \frac{308.46}{1 \text{,} 038.68} ) \times 25 = 17.58 \text{/} 25$

$33.21 \text{/} 50$

MATERIAL:

(2)

(a) Cost of Sales = 1,038.68 Cr.
Material Cost + E = 520.31 Cr.

× 4 × 8

$( 1 - \frac{Material Cost + E}{Cost of Sales} ) \times 4 \times 8$
$= ( 1 - \frac{520.31}{1 \text{,} 038.68} ) \times 4 \times 8 = 15.97 \text{/} 32$

(b) Cost of Sales = 1,038.68 Cr.

Inventory = 116.61 Cr.

× 6 × 8

$( 1 - \frac{Inventory}{Cost of Sales} ) \times 6 \times 8$
$= ( 1 - \frac{111.61}{1 \text{,} 038.68} ) \times 48 = 42.61 \text{/} 48$

$therefore ( a ) + ( b ) = 58.58 \text{/} 80$

| | MACHINE: |
|---|---|
| (3) | (a) Cost of Sales = 1,038.68 Cr. |
| | Depn. = 15.75 Cr. |

× 5 × 4

$( 1 - \frac{Depn .}{Cost of Sales} ) \times 5 \times 4$
$= ( 1 - \frac{15.75}{1 \text{,} 038.68} ) \times 20 = 19.70 \text{/} 20$

(b) Cost of Sales = 1,038.68 Cr.
WDV = 154.94 Cr.

× 5 × 4

$( 1 - \frac{WDV}{Cost of Sales} ) \times 5 \times 4$
$= ( 1 - \frac{154.94}{1 \text{,} 038.68} ) \times 20 = 17.02 \text{/} 20$

$therefore ( a ) + ( b ) = 36.72 \text{/} 40$

| | MANPOWER: |
|---|---|
| (4) | (a) Cost of Sales = 1,038.68 Cr. |
| | Direct Labour Cost = 52.91 Cr |

× 5 × 6

$( 1 - \frac{Direct Labour Cost}{Cost of Sales} ) \times 5 \times 6$
$= ( 1 - \frac{52.91}{1038.68} ) \times 30 = 28.47 \text{/} 30$

(b) Cost of Sales = 1,038.68 Cr.
No. of Direct Employees = 1,764

Cost of Sales/Direct employee = 58.88 lakhs

Industry avg. cost of sales/employee = 70 lakhs

$\frac{Co . avg . cost \text{/} direct employee}{2 \times industry avg . cos \text{/} direct employee} \times 5 \times 6$
$= \frac{58.88}{2 \times 70} \times 30 = 12.6 \text{/} 30$

$therefore ( a ) + ( b ) = 41.07 \text{/} 60$

| | MANAGEMENT: |
|---|---|
| (5) | (a) Cost of Sales = 1,038.68 Cr. |
| | Indirect Manpower cost = 22.67 Cr |

× 5 × 10

$( 1 - \frac{Indirect Manpower Cost}{Cost of Sales} ) \times 5 \times 10$
$= ( 1 - \frac{22.67}{1 \text{,} 038.68} ) \times 50 = 48.90 \text{/} 50$

(b) Cost of Sales = 1,038.68 Cr.
No. of Indirect employees = 378
Cost of Sales/indirect employee = 1,038.68/378. =
274.78 lakhs
Industry avg. cost of sales/indirect employee = 250 lakhs

$\frac{Co . avg . cost \text{/} indirect employee}{2 \times industry avg . cos \text{/} indirect employee} \times 5 \times 10$
$= \frac{274.78}{2 \times 250} \times 5 \times 10 = 27.48 \text{/} 50$
$therefore ( a ) + ( b ) = 76.38 \text{/} 100$

IT:

(6) Cost of Sales = 1,038.68 Cr.
IT Cost = 20 Cr.

$( 1 - \frac{IT Cost}{Cost of Sales} ) \times 10 \times 7$
$= ( 1 - \frac{20}{1 \text{,} 038.68} ) \times 70 = 68.65 \text{/} 70$

$68.65 \text{/} 70$

$COST MEASURE \text{:} Σ 314.61 \text{/} 400$

VALUE MEASURE: -

MONEY:

(1)

(a) S = 1,147.97 Crores.
(EVA/CE) = 21.71%

Co.

(EVA/CE) industry = 18%

$\frac{( EVA \text{/} CE ) co =}{2 \times ( EVA \text{/} CE ) industry} \times 5 \times 7.5$
$= \frac{21.71}{2 \times 18} \times 37.5 = 22.61 \text{/} 37.5$

| | |
|---|---|
| (b) | CE |

Sales
S = 1,147.97 Cr.
CE = 308.46 Cr.
$\frac{( 1 - CE )}{Sales} \times 5 \times 7.5$
$( 2 - \frac{308.46}{1 \text{,} 147.97} ) \times 37.5 = 27.42 \text{/} 37.5$

$therefore ( a ) + ( b ) = 50.03 \text{/} 75$

| | MATERIAL: |
|---|---|
| (2) | (a) S = 1,147.92 Cr. |
| | Material Cost + Energy = 520.31 Cr. |

$( 1 - \frac{( Material + E ) Cost}{Sales} ) \times 5 \times 12$
$= ( 1 - \frac{520.31}{1 \text{,} 147.97} ) \times 60 = 32.81 \text{/} 60$

(b) S = 1,147.97 Cr
Inventory = 116.61 cr

$( 1 - \frac{Inventory}{Sales} ) \times 5 \times 12$
$( 1 - \frac{116.61}{1 \text{,} 147.97} ) \times 60 = 53.90 \text{/} 60$

$therefore ( a ) + ( b ) = 86.71 \text{/} 120$

| | MACHINE: |
|---|---|
| (3) | (a) S = 1,147.97 Cr. |
| | Depn. = 15.75 Cr |

$( 1 - \frac{Depn .}{Sales} ) \times 5 \times 6$
$= ( 1 - \frac{15.75}{1 \text{,} 147.97} ) \times 30 = 29.59 \text{/} 30$

(b) S = 1,147.97 Cr
WDV = 154.94 Cr

$( 1 - \frac{WDV}{Sales} ) \times 5 \times 6$
$= ( 1 - \frac{154.94}{1 \text{,} 147.97} ) \times 30 = 25.95 \text{/} 30$

$therefore ( a ) + ( b ) = 55.54 \text{/} 60$

| | MANPOWER: |
|---|---|
| (4) | (a) Sales = 1,147.97 Cr. |
| | Direct Labour Cost = 52.91 Crores |

$( 1 - \frac{Direct Labour Cost}{Sales} ) \times 5 \times 9$
$= ( 1 - \frac{52.91}{1 \text{,} 147.97} ) \times 45 = 45.93 \text{/} 45$

```
(b) Sales = 1,147.97 Crore
  No of direct employees = 1,764
  Sales/direct employee = 65.08 lakhs
  Industry avg. sales/direct employee = 75 lakhs
```

$\frac{Co . avg . sales \text{/} direct employee}{2 \times industry avg . sales \text{/} direct employee} \times 5 \times 9$
$= \frac{65.08}{2 \times 75} \times 45 = 19.52 \text{/} 45$

$therefore ( a ) + ( b ) = 62.45 \text{/} 90$

| | MANAGEMENT: |
|---|---|
| (5) | (a) Sales = 1,147.97 Cr. |
| | Indirect Manpower Cost = 22.67 Cr |

$( 1 - \frac{Indirect Manpowr Cost}{S ales} ) \times 5 \times 15$
$= ( 1 - \frac{22.67}{1 \text{,} 147.97} ) \times 75 = 73.52 \text{/} 75$

(b) Sales = 1,147.97 Cr.

No. of indirect employees = 378
Sales/indirect employee = 303.70 lakhs
Industry avg. sales/indirect employee = 280 lakhs

$\frac{Co . avg . sales \text{/} indirect employee}{2 \times industry avg . sales \text{/} indirect employee} \times 5 \times 15$
$= \frac{303.70}{2 \times 280} \times 75 = 40.67 \text{/} 75$

$therefore ( a ) + ( b ) = 114.19 \text{/} 150$

| | |
|---|---|
| (6) | IT: |

Sales = 1,147.97 Cr.
IT Cost = 20 Cr.

$( 1 - \frac{IT Cost}{Sales} ) \times 10 \times 10.5$
$= ( 1 - \frac{20}{1 \text{,} 147.97} ) \times 105 = 103.17 \text{/} 105$

$103.17 \text{/} 105$

$VALUE MEASURE \text{:} Σ 472.09 \text{/} 600$

NON FINANCIAL PERFORMANCE MEASURE

| | |
|---|---|
| 1) CUSTOMER: | 60/100 |
| 2) QUALITY: | 60/100 |
| 3) EMPLOYEE: | 80/150 |
| 4) STRATEGY: | 70/150 |

Σ = 270/500

| | |
|---|---|
| FMCG Ltd. | $ΣΣ = \frac{1056.70}{1500}$ |
| RTP Rating Grade: PP | |

### EXAMPLE III

A) Business

Sector: Service

B) Name of the Company: CS Ltd.

C) Business Operations: In a world where listening to customers is merely a basic requirement for success, the company has gone several steps ahead in customising every function within the organization, be it people, process, technology, or, solution delivery, to focus or delivering what customers' business demands. Perhaps, it is this leadership trait that has won the company an available list of over 300 global customers, including more than 100 Fortune Global 500 companies.

The company is an information technology (IT) services provider that uses a global infrastructure to deliver value-added services to its customers, to address IT needs in specific industries and to facilitate electronic business, or, e-Business, initiatives. The Company has offshore development centers located throughout India that enables it to provide high quality and cost-effective solutions to clients. It also has offsite centers located in the United States, United Kingdom, Germany, Singapore, Malayasia, Australia, Japan and Dubai. The range of services offered by it, either on a “time and material” basis, or, “fixed price”, includes consulting, systems design, software development, system integration and application maintenance.

The Company offers a comprehensive rang of IT services, including software development, packaged software integration system maintenance and engineering design services. The Company has established a diversified base of corporate customers in a wide range of industries including insurance, banking and financial services, manufacturing, telecommunications, transportation and engineering services.

During the financial year 2003-04, the company recorded total revenues of US$ 576.54 million, comprising income from software services of US$558.58 million, other income of US$17.96 millions, and a net profit of US$122.15 millions. North America, Japan, Europe and the rest of the world contributed 73.34%, 1.97%, 13.71% and 10.98% respectively, to the total revenues. The offshore share of the revenues during the year was 42.7%, while the onsite share was 57.3%.

D) Financials:

| | Units in US$ millions | |
|---|---|---|
| | For the | |
| | year | |
| | Ending on | For the yr |
| Profit & Loss Account | 31.3.04 | 31.3.03 |
| Income: | | |
| Services: Export: | 543.29 | 440.28 |
| Domestic: | 15.28 | 4.47 |
| Other Income | 17.96 | 6.12 |
| Expenditure: | 576.53 | 450.87 |
| Personnel Expenses: | 294.05 | 215.48 |
| Operating & Administrative Expenses | 112.32 | 93.33 |
| Financial Expenses: | 0.16 | 0.15 |
| Depreciation & Amortisation: | 24.43 | 27.29 |
| | 431.06 | 336.25 |
| Profit Before Taxation and | 145.47 | 113.62 |
| Non-recurring/Extra ordinary Items: | | |
| Provision for Taxation: | | |
| Current: | 23.74 | 14.43 |
| Deferred: | (0.41) | (0.90) |
| Earlier years: | — | 0.01 |
| Profit After Taxation and Before | 122.14 | 101.08 |
| Non-recurring/Extra ordinary Items | | |
| Provision for dimension in value of | — | 33.50 |
| Investments/advances and debtors: | | |
| Profit After Taxation and Non-recurring/ | 122.14 | 67.58 |
| Extraordinary Items: | | |
| Add: Balance brought forward from | 249.48 | 212.29 |
| Previous year: | | |
| Profit Available for appropriation | 371.62 | 279.87 |
| Appropriations: | | |
| Interim Dividend: | 8.31 | 5.53 |
| Final Dividend: | 19.54 | 15.07 |
| Tax on distributed profits: | 3.57 | 1.95 |
| Transfer to General Reserve: | 13.18 | 7.69 |
| Balance carried to Balance sheet: | 327.02 | 249.63 |
| Balance Sheet | As on | As on |
| | 31.3.04 | 31.3.03 |
| Sources of funds | | |
| Shareholders' Funds: | | |
| (a) Share Capital | 13.90 | 13.82 |
| (b) Share application money, pending allotment: | 0.04 | — |
| (c) Reserves & Surplus: | 553.30 | 455.38 |
| 2. Loan Funds: | 567.24 | 469.20 |
| (a) Secured Loans: | 1.60 | 1.42 |
| (b) Unsecured Loans | — | 2.61 |
| | 568.84 | 473.23 |
| II) Application of Funds: | | |
| 1. Fixed Assets: | | |
| (a) Gross Block | 186.19 | 170.53 |
| (b) Less: Depreciation | 131.37 | 106.28 |
| (c) Net Block | 54.82 | 64.25 |
| (d) Capital Work-in-Progress: | 4.87 | 5.93 |
| | 59.69 | 70.18 |
| 2. Investments | 16.43 | 12.66 |
| 3. Deferred Tax Assets (net) | 1.56 | 0.76 |
| 4. Current Assets, Loans and Advances | | |
| (a) Sundry Debtors | 130.29 | 105.47 |
| (b) Cash and Bank Balances | 398.98 | 334.80 |
| (c) Loans and Advances | 19.91 | 22.99 |
| (d) Other Current Assets | | |
| Interest Accrued on Fixed Deposits | 20.09 | 4.06 |
| Less: current liabilities & provisions | 569.27 | 467.32 |
| (a) Liabilities | 42.34 | 40.68 |
| (b) Provisions | 34.95 | 37.01 |
| Net Current Assets: | 491.16 | 389.63 |
| | 568.84 | 473.23 |

RTP-Rating Calculation:

CS Ltd

${A}^{*} \underline{Industry Domain} \text{:} Service$
Units in INR
1 USD = 45.5 INR
1 lakh TNR = 1,00,000 INR
1 cr. INR = 100 lakh INR

| Cost Measure: | |
|---|---|
| | MONEY: |
| (1) | (a) WACC = 16% |
| | Risk Free = 5.5% |

$\frac{WACC}{Risk Free} = \frac{16}{5.5} = 2.91$
$( 1 - \frac{Risk free rate}{WACC} ) \times 5 \times 5$
$= ( 1 - \frac{1}{2.91} ) \times 25 = 16.41 \text{/} 25$

(b) Cost of Sales = 1,961 Cr.

CE = 2,588 Cr.

Paid-up Capital 63.25 Cr
Reserves: 2517 cr.
Debt Capital: 7.3 Cr.

$( 1 - \frac{CE}{COS} ) \times 5 \times 5$
$= ( 1 - \frac{2588}{1961} ) \times 5 \times 5 = - 7.99 \text{/} 25$

$therefore ( a ) + ( b ) = 8.42 \text{/} 50$

MATERIAL:

(2)

(a) Cost of Sales = 1,961 Cr.
Material Cost + E = 17.2 Cr.
$\times 4 ( 1 - \frac{Material Cost + E}{Cost of Sales} ) \times 4 \times 3$
$= ( 1 - \frac{17.2}{1961} ) \times 12 = 11.89 \text{/} 12$
(b) Cost of Sales = 1,961 Cr.
Inventory = 0 Cr.

$\times 6 ( 1 - \frac{Inventory}{Cost of Sales} ) \times 6 \times 3$
$= ( 1 - \frac{0}{1961} ) \times 18 = 18 \text{/} 18$

$therefore ( a ) + ( b ) = 29.89 \text{/} 30$

| | MATERIAL: |
|---|---|
| (3) | (a) Cost of Sales = 1,961 Cr. |

Depn. = 111.6 Cr.

$( 1 - \frac{Depn .}{Cost of Sales} ) \times 5 \times 3$
$= ( 1 - \frac{111.6}{1961} ) \times 15 = 14.15 \text{/} 15$

(b) Cost of Sales = 1,961 Cr.

WDV = 2.71.40 Cr.

$( 1 - \frac{WDV}{Cost of Sales} ) \times 15 = 12.92 \text{/} 25$

$therefore ( a ) + ( b ) = 27.07 \text{/} 30$

| | MANPOWER: |
|---|---|
| (4) | (a) Cost of Sales = 1,961 Cr. |

```
  Direct Labour Cost = 1,338 × 0.7 = 936.6 Cr.
$5 \times 12.5 \times ( 1 - \frac{Direct Labour Cost}{Cost of Sales} )$
$= ( 1 - \frac{936.6}{1961} ) \times 5 \times 12.5 = 32.65 \text{/} 62.5$
(b) Cost of Sales = 1,961 Cr.
  No. of Direct Employees = 15,600
```

Cost of Sales/Direct employee = 12.6 lakhs

Industry avg. cost of sales/employee = 15 lakhs

$\frac{Co . avg . cost \text{/} direct employee}{2 \times industry avg . cos \text{/} direct employee} \times 5 \times 12.5$
$= \frac{12.6}{2 \times 15} \times 5 \times 12.5 = 26.25 \text{/} 62.5$

$therefore ( a ) + ( b ) = 58.9 \text{/} 125$

| | MANAGEMENT: |
|---|---|
| (5) | (a) Cost of Sales = 1,961 Cr. |

Indirect Manpower cost = 1338 × 0.3 = 401.4 Cr
$( 1 - \frac{Indirect Manpowr Cost}{S ales} ) \times 5 \times 12.5$

$= ( 1 - \frac{401.4}{1961} ) \times 62.5 = 49.71 \text{/} 62.5$

(b) Cost of Sales = 1,961 Cr.
No. of Indirect employees = 2340
Cost of Sales/indirect employee = 83.80 lakh.
Industry avg. cost of sales/indirect employee = 70 lakhs
(assumed)

$\frac{Co . avg . cos \text{/} indirect employee}{2 \times industry avg . cos \text{/} indirect employee} \times 5 \times 12.5$
$= \frac{83.8}{2 \times 70} \times 62.5 = 37.41 \text{/} 62.5$

$therefore ( a ) + ( b ) = 87.12 \text{/} 125$

(6) IT:

Cost of Sales = 1,961 Cr.
IT Cost = 22 Cr.

$( 1 - \frac{IT Cost}{Cost of Sales} ) \times 10 \times 4$
$= ( 1 - \frac{22}{1961} ) \times 40 = 39.5 \text{/} 40$

$COST MEASURE \text{:} Σ 250.9 \text{/} 400$

VALUE MEASURE: -
MONEY:
1. (a) S = 2623 Crores.

| | |
|---|---|
| EVA = 178.52 crores | (EVA/CE) industry = 6.89% |

| | |
|---|---|
| CE = 2588 Cr. | (EVA/CE) co = 10% |

| (Paid-up: 63.25 cr | |
|---|---|
| Reserves: 2517 cr | |
| Debt: 7.3 cr | |
| S = 2623 Crores. | |
| | (EVA/CE) industry = 6.89% |
| $\frac{( EVA \text{/} CE ) co =}{2 \times ( EVA \text{/} CE ) industry} \times 5 \times 7.5 = 12.92 \text{/} 37.5$ | |
| (b) | $\frac{CE}{Sales}$ |
| | $( 3 - \frac{2588}{2623} ) \times 7.5 \times 5 = 0.5 \text{/} 37.5$ |

$therefore ( a ) + ( b ) = 13.42 \text{/} 75$

| | MATERIAL: |
|---|---|
| (2) | (a) Material Cost + Energy = 17.2 Cr. |

S = 2623 Cr.
$( 1 - \frac{( Material + E ) Cost}{Sales} ) \times 5 \times 4.5$
$= ( 1 - \frac{17.2}{2623} ) \times 22.5 = 22.35 \text{/} 22.5$

(b) S = 2623 Cr

Inventory = 0

$( 1 - \frac{Inventory}{Sales} ) \times 5 \times 4.5 = 22.5 \text{/} 22.5$
$therefore ( a ) + ( b ) = 44.85 \text{/} 45$

MACHINE:
(3) (a) S = 2623 Cr.

Depn. = 111.6 Cr

$( 1 - \frac{Depn .}{Sales} ) \times 5 \times 4.5$
$= ( 1 - \frac{111.6}{2623} ) \times 22.5 = 21.54 \text{/} 22.5$

(b) S = 2623 Cr

WDV = 271.4 Cr.

$( 1 - \frac{WDV}{Sales} ) \times 5 \times 4.5$
$= ( 1 - \frac{271.4}{2623} ) \times 22.5 = 20.17 \text{/} 22.5$

$therefore ( a ) + ( b ) = 41.71 \text{/} 45$

MANPOWER:

(4) (a) Sales = 2623 Cr.

Direct Labour Cost = 936.6 Crores

$( 1 - \frac{Direct Labour Cost}{S ales} ) \times 5 \times 18.75$
$= ( 1 - \frac{936.6}{2623} ) \times 5 \times 18.75 = 60.27 \text{/} 93.75$

(b) Sales = 2623 Crore
No of direct employees = 15,600
Sales/direct employee = 16.81 lakhs
Industry avg. sales/direct employee = 20 lakhs

$\frac{Co . avg . sales \text{/} direct employee}{2 \times industry avg . sales \text{/} direct employee} \times 5 \times 18.75$
$= \frac{16.81}{2 \times 20} \times 5 \times 18.75 = 39.40 \text{/} 93.75$

$therefore ( a ) + ( b ) = 99.67 \text{/} 187.5$

MANAGEMENT:
(a) Sales = 2623 Cr.
Indirect Manpower Cost = 401.4 Cr

$( 1 - \frac{Indirect Manpowr Cost}{S ales} ) \times 5 \times 18.75$
$= ( 1 - \frac{401.4}{2623} ) \times 93.75 = 79.40 \text{/} 93.75$

$( b ) Sales = 2623$

Cr.

No. of indirect employees = 2,340
Sales/indirect employee = 112.10 lakhs
Industry avg. sales/indirect employee = 100 lakhs

$\frac{Co . avg . sales \text{/} indirect employee}{2 \times industry avg . sales \text{/} indirect employee} \times 5 \times 18.75$
$= \frac{112.10}{2 \times 100} \times 93.75 = 52.55 \text{/} 93.75$

$therefore ( a ) + ( b ) = 131.95 \text{/} 187.5$

(5) IT:

Sales = 2623 Cr.
IT Cost = 22 Cr.

$( 1 - \frac{IT Cost}{Sales} ) \times 10 \times 6$
$= ( 1 - \frac{22}{2623} ) \times 60 = 59.5 \text{/} 60$

$59.5 \text{/} 60$

$VALUE MEASURE \text{:} Σ 391.1 \text{/} 600$

NON FINANCIAL PERFORMANCE MEASURE

| | |
|---|---|
| 1) CUSTOMER: | 90/100 |
| 2) QUALITY: | 80/100 |
| 3) EMPLOYEE: | 90/150 |
| 4) STRATEGY: | 100/150 |

Z = 360/500

| | |
|---|---|
| C S Ltd. | $ΣΣ = \frac{1002}{1500}$ |

RTP Rating Grade: PP

1. A resource based costing method for evaluation of business performances of business enterprise, said method consisting of evaluating resource based cost weightages for the type of business of the enterprise, and variables of resources such as money, material and energy, machines, manpower, management and information respectively; using the weightages so evaluated to score cost drivers relating to the said business enterprise on a grade 1 to 400 RTP points, evaluating the value weightages for type of business of the business enterprise and individual weightages for output such as money, material and energy, machines, manpower, management and information; and using the evaluated value weightages to score value drivers relating to the said business enterprise on a grade 1 to 600 RPT points, evaluating parameter weightages of parameters such as Quality, Employees, Customers & Strategy-representing pro-active nature of the management and using the evaluated parameter weightages to grade a set of non-financial performance measure in the form of pre-prepared questions on a scoring index of 1 to 500 RTP points, adding the individual scores so achieved to a maximum of 1500 RTP points giving a score for evaluation of the business performance.

2. A method for evaluation of business performances of business enterprise as claimed in claim 1, in which any one of the weightages are alterable to suit dynamic real life situations.

3. An apparatus for carrying out the method of evaluation of business performances of business enterprise as claimed in claim 1, said apparatus consisting of a scorecard for cost drivers graded on 400 RTP points, a scorecard for value drivers graded on 600 RTP points, and a set of non-financial performance measure questionnaires having a measurement index of 500 RTP points all adding up to a score of a maximum of 1500 RTP points said scorecard for cost drivers including weightages for the type of business and variables of resources such as money, material and energy, machines, manpower, management and information; and the said scorecard for value drivers including weightages for type of business and variables of output such as money, material and energy, machines, manpower, management and information; and the said questionnaires separately giving weightages to parameters such as Quality, Employees, Customers & Strategy-representing pro-active nature of the management.

4. An apparatus for evaluation of business performances of business enterprise, as claimed in claim 1, in which the scorecard for cost drivers includes further subdivisions for variable cost measures.

5. An apparatus for evaluation of business performances of business enterprise, as claimed in claim 1, in which the scorecard for value drivers includes further subdivisions for variable value measures.

6. An apparatus for evaluation of business performances of business enterprise, as claimed in claim 1 in which the questionnaires are further subdivided into individual questions that have separately identified weightages.

7. An apparatus for evaluation of business performances of business enterprise, as claimed in claim 1, in which the weightages are alterable to suit dynamic situations, real life situations.
